(19) United States
(12) Patent Application Publication
(10) Pub. No.: US 2004/0027021 A1
(43) Pub. Date: Feb. 12, 2004

(54) Switched reluctance motor having radial and transverse flux

(76) Inventors: Roland Karrelmeyer, Ditzingen (DE); Elmar Dilger, Leinfelden-Echterdingen (DE)

Correspondence Address: KENYON & KENYON, ONE BROADWAY, NEW YORK, NY, 10004, US

(21) Appl. No.: 10/343,249

(22) PCT Filed: May 28, 2002
(86) PCT No.: PCT/DE02/01956

(51) Int. Cl. H02K 17/42; H02K 19/20

(52) U.S. Cl. 310/168

(57) ABSTRACT

A switched, brushless reluctance motor (10) has a radial flux stator (12), on whose radial flux poles (15 through 18) electrical radial flux coils (21 through 24) are situated for generating a radial magnetic flux (13) acting in the radial direction upon a rotatably mounted armature (11) having at least two armature poles (19, 20), a rotating motion being impartable to the armature (11) by applying a cyclically switched power to the radial flux coils (21 through 24); during said rotation the at least two armature poles (19, 20) are rotated in the direction of the radial flux poles (15, 17) which are magnetically excited at the time in order to shorten the particular radial magnetic flux path passing through the armature poles (19, 20). The reluctance motor has a transverse flux stator (27; 57), whose transverse flux poles (28a, 28b through 31a, 31b) are associated with electrical transverse flux coils (36 through 39) for generating a transverse magnetic flux (41, 42) acting upon the armature (11) in the transverse direction, a rotating motion being impartable to the armature (11) by applying a cyclically switched power to the transverse flux coils (36 through 39).

### BACKGROUND INFORMATION

The present invention relates to a switched, brushless reluctance motor having a radial flux stator, using which a radial magnetic flux acting on a rotatably mounted armature in the radial direction is obtainable. A revolving magnetic field is generated by the cyclically switched power applied to the radial flux coils situated on the radial flux poles of the radial flux stator, and a rotating motion is imparted to the armature. The poles of the armature are moved in the direction of the particular magnetically excited radial flux poles, so that the radial magnetic flux from the radial flux poles via the armature travels over the shortest possible path.

Switched reluctance motors, also known as SR motors, have a relatively simple design and a high degree of dependability. Coils, which are cyclically energized by a power supply device, normally a power converter, are only mounted on the ring flux stator. Typically, the current has a triangular or saw-toothed shape. The armature is made of a magnetically conductive material, for example, a ferromagnetic material, and has no electrical contacts with the stator, which is the reason why an SR motor is in principle well suited for applications requiring a high degree of dependability such as in aerospace applications, electrical steering systems in the automobile industry, and the like. Since no electrical commutation takes place on the motor itself, the SR motor is also well suited for explosion risk environments such as in mining.

However, a ring stator is only capable of generating magnetic power acting on the armature to a limited extent. Another problem is that the SR motor overall is no longer operational in the event of a failure of the power supply device supplying the radial flux stator.

### ADVANTAGES OF THE INVENTION

In the switched, brushless reluctance motor according to the present invention, a transverse flux stator, capable of generating a transverse magnetic flux acting on the armature in the transverse direction, is provided in addition to the radial flux stator. Therefore, the magnetic flux flows through the armature not only in the radial, but also in the transverse direction. Thus a higher magnetic power density is obtained, which ultimately results in a higher performance of the SR motor. Furthermore, the SR motor according to the present invention is also more dependable, since each of the two stators, i.e., the radial flux stator and the transverse flux stator, is energizable independently of the other stator.

Advantageous embodiments of the present invention result from the dependent claims and the description.

The armature poles are advantageously each movably situated between two associated transverse flux poles having opposite magnetic orientations. In this way the transverse magnetic flux has an optimum effect on the armature.

The transverse flux stator advantageously has at least two transverse flux yokes which each connect two associated transverse flux poles having opposite magnetic orientations.

Different variants are possible for the design of the transverse flux yokes, two of which will be elucidated below. Combinations of the variants explained below are also possible.

The transverse flux yokes are advantageously situated at least partially on the side of the radial flux stator opposite the armature, so that the magnetic flux flowing through the particular transverse flux yoke is conducted past the side of the radial flux stator opposite the armature. When the SR motor according to the present invention has an internal rotor design, the transverse flux yokes are situated outside on the radial flux stator, the magnetic flux flowing through the transverse flux yoke being conducted past the radial flux stator on the outside.

The transverse flux yokes may be designed as components that are independent of the radial flux stator. However, the transverse flux yokes may advantageously also be partially formed from the radial flux stator, which thus conducts not only radial magnetic fluxes, but also transverse magnetic fluxes.

In an alternative design of the transverse flux yokes, which however is also utilizable in principle in combination with the above-described design of the transverse flux yokes, the transverse flux yokes are each situated on opposite end faces of the armature, a first transverse flux yoke having first transverse flux poles being situated on one end face and a second transverse flux yoke having second transverse flux poles, which are magnetically associated with the first transverse flux poles, being situated on the opposite end face. The transverse flux yokes may be designed as couplers and, for example, a plurality of transverse flux yokes situated on one end face of the armature may be connected together at a central coupling point.

The transverse flux poles and the radial flux poles are advantageously situated at an offset, at least one transverse flux pole being advantageously situated at an offset between two radial flux poles so that a smoother armature torque variation is achievable. It is understood that in order to achieve a smooth torque variation, not only are the transverse flux poles and the radial flux poles advantageously situated at an offset, but also the transverse flux poles and radial flux poles are suitably energized.

In order to enhance the dependability of the reluctance motor according to the present invention, a first power supply system is provided for energizing the radial flux coils, and a second power supply system is provided for energizing the transverse flux coils. Power converters are suitable, for example, as power supply systems.

The power supply systems, i.e., the power converters, are advantageously coupled together, so that the radial flux coils and the transverse flux coils are energized in a coordinatable manner. Using this measure, the above-mentioned smooth armature torque variation in particular is achievable.

The two power supply systems are preferably designed so that in the event of failure of one power supply system, the other one may continue to operate. Thus at least one power supply system is operable, so that ultimately the reluctance motor according to the present invention is ready to operate even in the event of failure of one power supply system.

In principle, it is also possible to provide a common power supply system, for example, a single power converter, for energizing both the transverse flux coils and the radial flux coils. This common power supply system, if necessary, may be designed to be particularly reliable using appropriate measures, for example, by duplicating components.

The magnetic flux flows through the armature in both the radial and transverse directions; therefore, the armature is preferably made essentially of ferrite or a sintered metal having poor electrical, but good magnetic conductivity. Such a material is also preferable for the above-mentioned measure where the transverse flux yokes are partially formed from the radial flux stator. Those areas of the radial flux stator through which both radial and transverse magnetic fluxes flow are preferably made of ferrite or a sintered metal, which has poor electrical, but good magnetic conductivity.

The radial flux stator preferably has an essentially annular shape. Other designs, for example, rectangular outer contours or the like, are of course also conceivable.

### DRAWING

Exemplary embodiments of the present invention are illustrated in the drawing and elucidated in more detail in the description that follows.

FIG. 1A shows a top view of a switched reluctance motor 10 according to the present invention, in which transverse flux yokes are situated on the outside of the ring flux stator;

FIG. 1B shows a cross section of reluctance motor 10 along a section line A-A in FIG. 1A;

FIG. 2A shows a top view of a reluctance motor 50 according to the present invention, in which transverse flux yokes are each situated on opposite end faces of its armature 51, spanning the armature;

FIG. 2B shows a cross section along a section line B-B of reluctance motor 50 of FIG. 2A.

### DESCRIPTION OF THE EXEMPLARY EMBODIMENTS

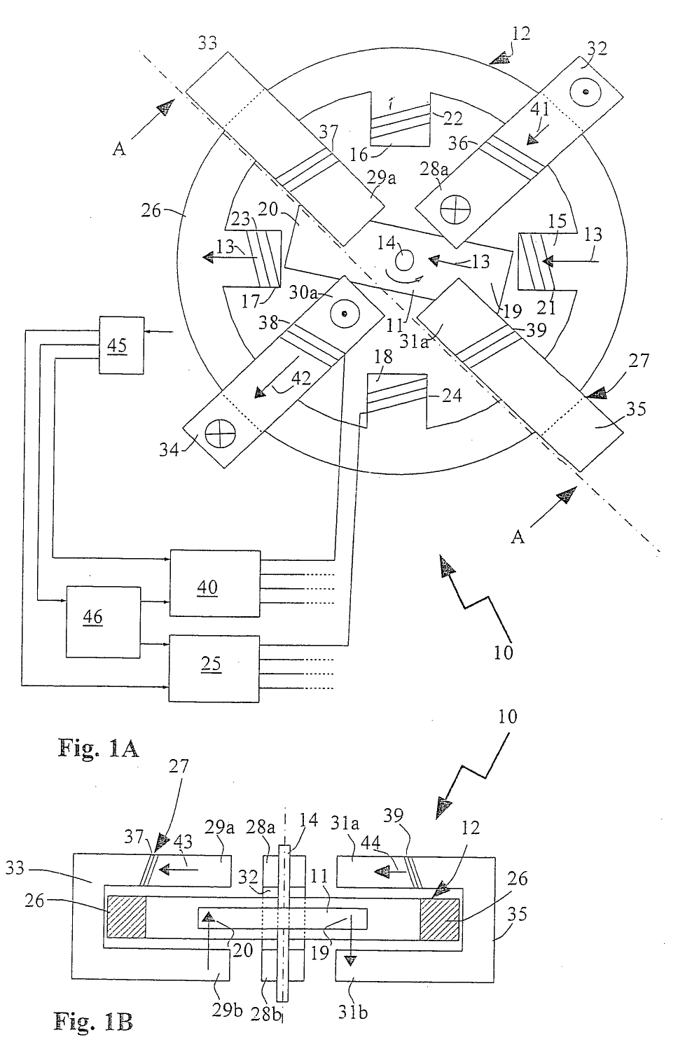

In the following, switched, brushless reluctance motor 10 according to FIGS. 1A, 1B is first explained. A radial flux stator 12 is used for generating a radial magnetic flux acting in the radial direction on an armature 11, which is rotatably mounted on a rotating shaft 14. Radial flux 13 flows from radial flux poles 15, 17, and 16, 18 of radial flux stator 12 via armature poles 19, 20 of armature 11. Radial flux coils 21 through 24, which are cyclically energized by a power converter 25 forming a power supply system, are situated on radial flux poles 15 through 18. Coils 21 through 24 are energized, for example, as a function of the position and/or rotational speed of armature 11. Power converter 25 may contain a control and regulating unit suitable for this purpose.

In the position of armature 11 shown in FIG. 1A, radial magnetic flux 13 flows from ring stator pole 15 to armature pole 19 and via armature 11 to armature pole 20. From there, radial flux 13 flows to radial flux pole 17. The magnetic circuit is closed by a stator ring 26, on which radial flux poles 15 through 18 are situated. It should be pointed out here that although the drawing is schematic, it shows, with respect to the design of radial flux poles 15 through 18, a typical feature of switched reluctance motors, namely that the radial flux poles project all the way to the armature. It is to be understood, however, that this feature is not mandatory.

Armature 11 attempts to shorten the path of magnetic flux 13, armature 11 being rotated from the position shown in the direction of radial flux poles 15, 17, so that a torque is obtained which may be taken off rotating shaft 14. After radial flux coils 21, 23, radial flux coils 22, 24 are energized, so that armature 11 continues its rotational motion, indicated by an arrow situated next to rotating shaft 14.

In addition to radial flux stator 12, reluctance motor 10 has a transverse flux stator 27 having transverse flux poles 28a, 28b through 31a, 31b (in FIG. 1A only transverse flux poles having indices “a” i.e., 28a through 31a, are visible). Transverse flux poles 28a, 28b are connected to one another through a transverse flux yoke 32; transverse flux poles 29a, 29b through 31a, 31b are connected to one another through transverse flux yokes 33 through 35, respectively.

Transverse flux coils 36 through 39, cyclically energized by a power converter 40, are situated on transverse flux yokes 32 through 35. Power converter 25 forms a first power supply system, and power converter 40 forms a second power supply system. In order to simplify the representation, in the drawing only one transverse flux coil 36 through 39 is associated with each transverse flux yoke 32 through 35—more transverse flux coils are also possible. It is, for example, also possible that one transverse flux coil is associated with each of the transverse flux poles 28a, 28b through 31a, 31b.

A transverse flux acting on armature 11 in the transverse direction, i.e., parallel to axis of rotation 14, is obtainable using transverse flux coils 36 through 39, it being possible to impart a rotating motion to armature 11 as a cyclically switched power is applied to transverse flux coils 36 through 39 by power converter 40. Thus, reluctance motor 10 is further operable even in the event of a failure of power converter 25.

Exemplary transverse magnetic fluxes 41, 42 are shown for transverse flux poles 28a, 28b and 30a, 30b in FIG. 1A. Transverse fluxes 41, 42 are achieved by energizing transverse flux coils 36 and 38, respectively.

Armature 11 attempts to shorten the path of transverse fluxes 41, 42, armature pole 19 rotating in the direction of transverse flux poles 28a, 28b, and armature pole 20 rotating in the direction of transverse flux poles 30a, 30b.

Additional exemplary transverse magnetic fluxes 43, 44 are shown in FIG. 1B. Transverse fluxes 43, 44 are generated by energizing transverse flux coils 37 and 39, respectively, and flow via transverse flux yokes 33 and 35, respectively, which are situated on the outside of radial flux stator 12. With respect to FIG. 1B, it should also be noted that armature 11 assumes a position different from that in FIG. 1A and for the sake of clarity and to simplify the drawing, radial flux poles 15, 16 are not shown although they are actually visible.

In the embodiment shown in FIG. 1A, transverse flux yokes 32 through 35 are carried past ring 26 of radial flux stator 12. They are made of transformer sheets which are layered in the radial direction. In a similar manner, radial flux stator 12 preferably contains transformer sheets which are layered transversely to axis of rotation 14.

In principle, transverse flux yokes could also be formed from the radial flux stator, at least partially, a stator ring, for example, conducting the transverse magnetic flux.

In FIG. 1B, transverse flux stator 27 is shown to be situated at a distance from radial flux stator 12. In this design, however, it would also be possible for the transverse flux stator to be situated directly on the radial flux stator.

In this exemplary embodiment, power converters 25 and 40 are operable independently of one another, so that a high degree of operating dependability of reluctance motor 10 is achievable. A detection device 45 supplies power converters 25, 40, independently of one another, with actual values (indicated by arrows not shown in detail) with respect to reluctance motor 10, for example, the particular position of armature 11, so that power converters 25, 40 may cyclically energize radial flux poles 15 through 18 and transverse flux poles 28a, 28b through 31a, 31b in an appropriate manner.

Power converters 25, 40 are also controlled by a central controller 46, so that radial flux stator 12 and transverse flux stator 27 are energized in a coordinated manner. Detection device 45 also supplies controller 46 with actual values and triggers power converters 25 and 40 as a function of these actual values and of setpoint values (not shown), so that, for example, in the position of armature 11 shown in FIG. 1A, radial flux coils 21, 23 are energized first and then transverse flux coils 36, 38.

In reluctance motor 10 transverse flux poles 28a, 28b through 31a, 31b are situated at an offset with respect to radial flux poles 15 through 18, each transverse flux pole being situated in the middle between two radial flux poles. This fact, in conjunction with the coordinated triggering of power converters 25, 40, contributes to the smoothest possible variation of the torque that can be taken off rotation shaft 14. Due to the positioning of the transverse flux poles in the middle between the radial flux poles, this smooth torque variation is possible in both directions of rotation.

In principle, it is also conceivable, if a reluctance motor according to the present invention is provided for operation in one direction only, not to situate each of the transverse flux poles in the middle between radial flux poles. They may also be situated, for example, closer to the radial flux pole that precede them in the direction of rotation of the armature.

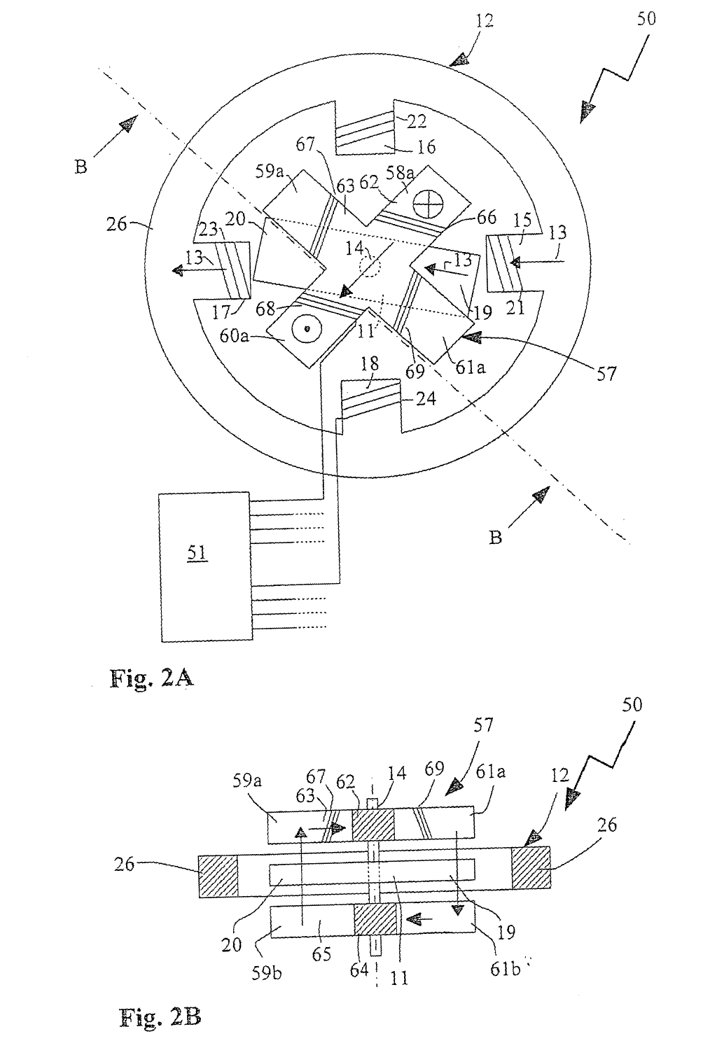

The reluctance motor shown in FIGS. 2A, 2B has the same design, with respect to its components concerning the radial flux, as reluctance motor 10, with the only difference that instead of power converter 25, a power converter 51 is provided which also supplies power to the components related to the transverse magnetic flux to be explained later. The components of reluctance motor 50 related to the radial magnetic flux are therefore identified with the same symbols as those of reluctance motor 10.

A transverse flux stator 57 of reluctance motor 50 has transverse flux poles 58a, 60a; 59a, 61a; 58b, 60b; 59b, 61b, which are connected to one another via yokes 62, 63, 64, and 65, respectively. Transverse flux poles 58b through 61b and transverse flux yokes 64, 65 are not visible in FIG. 2A. Transverse flux yokes 62, 63 are located on the upper end face of armature 11, while transverse flux yokes 64, 65 are located on its lower end face, transverse flux yokes 62 through 65 spanning the respective end faces. Transverse flux yokes 62, 63 and 64, 65 are cross connected to one another. Rotating shaft 14 passes through transverse flux yokes 62, 63 and 64, 65 and is rotatably mounted on the same, for example. However, in principle it is also possible that the transverse flux yokes spanning the armature on the end face side be located next to the rotating shaft of the armature.

Transverse flux coils 66, 67, 68, and 69, which may generate a transverse magnetic flux flowing through armature 11 in the transverse direction, i.e., parallel to axis of rotation 14, are situated on transverse flux yokes 62 through 65, respectively. Armature 11 attempts to shorten the path of the transverse magnetic flux, and rotates in the direction of those transverse flux poles 58a through 61b, which are magnetically excited at the time. In the embodiment according to FIGS. 2A, 2B, power converter 51, which also energizes radial flux coils 21 through 24, is provided for supplying transverse flux coils 66 through 69. A detection device for detecting actual values with respect to reluctance motor 50 is not shown in FIG. 2A for the sake of clarity.

It is understood that additional variants of the present invention are also possible in principle. Furthermore, the measures recited in the description and in the claims may be combined in any desired way.

The switched reluctance motors of the exemplary embodiments are known as 4/2 motors having four radial flux poles and two armature poles. The underlying idea of the present invention, however, is applicable in principle to all types of switched reluctance motors, for example, also to 3/2 motors or 6/8 motors. One preferred embodiment of the present invention provides 6/4 motors.

The number of transverse flux poles does not necessarily need to correlate with the number of radial flux poles; for example, in the exemplary embodiment, twice as many transverse flux poles are provided than radial flux poles. In principle it is also possible to provide four times as many transverse flux poles as radial flux poles or the same number of transverse flux poles and radial flux poles.

It is understood that the radial flux stator and the transverse flux stator may form one compact component.

The concept according to the present invention may also be used in motors having external rotors.

What is claimed is:

1. A switched, brushless reluctance motor (10; 50) comprising a radial flux stator (12), on whose radial flux poles (15 through 18) electrical radial flux coils (21 through 24) are situated for generating a radial magnetic flux (13) acting in the radial direction upon a rotatably mounted armature (11) having at least two armature poles (19, 20), a rotating motion being impartable to the armature (11) by applying a cyclically switched power to the radial flux coils (21 through 24); during the rotation the at least two armature poles (19, 20) are rotated in the direction of the radial flux poles (15, 17) which are magnetically excited at the time in order to shorten the particular radial magnetic flux path passing through the armature poles (19, 20),
wherein the reluctance motor has a transverse flux stator (27; 57), whose transverse flux poles (28a, 28b through 31a, 31b; 58a, 58b through 61a, 61b) are associated with electrical transverse flux coils (36 through 39; 66 through 69) for generating a transverse magnetic flux (41, 42) acting upon the armature (11) in the transverse direction, a rotating motion being impartable to the armature (11) by applying a cyclically switched power to the transverse flux coils (36 through 39; 66 through 69).

2. The reluctance motor as recited in claim 1,
wherein the transverse flux poles (28a, 28b through 31a, 31b; 58a, 58b through 61a, 61b) are situated in such a way that the armature poles (19, 20) are each movably situated between two associated transverse flux poles (28a, 28b through 31a, 31b; 58a, 58b through 61a, 61b) having opposite magnetic orientations.

3. The reluctance motor as recited in claim 1 or 2,
wherein the transverse flux stator (27; 57) has at least two transverse flux yokes (32 through 35; 62 through 65) which each connect two associated transverse flux poles (28a, 28b through 31a, 31b; 58a, 58b through 61a, 61b) having opposite magnetic orientations.

4. The reluctance motor as recited in one of the preceding claims,
wherein the transverse flux yokes (32 through 35) are situated at least partially on the side of the radial flux stator (12) opposite the armature (11), in particular on the outside of the radial flux stator (12), in such a manner that the magnetic flux flowing through the particular transverse flux yoke (32 through 35) is conducted past the side of the radial flux stator (12) opposite the armature (11), i.e. on the outside past the radial flux stator (12).

5. The reluctance motor as recited in claim 4,
wherein the transverse flux yokes (32 through 35) are partially formed from the radial flux stator (12).

6. The reluctance motor as recited in one of the preceding claims,
wherein the transverse flux yokes (62 through 65) are each situated on opposite end faces of the armature (11), spanning it in the shape of a coupling arch in particular, a first transverse flux yoke (62, 63) having first transverse flux poles (58a, 60a; 59a, 61a) being situated on one end face and a second transverse flux yoke (64, 65) having second transverse flux poles (58b, 60b; 59b, 61b), which are magnetically associated with the first transverse flux poles (58a, 60a; 59a, 61a), being situated on the opposite end face.

7. The reluctance motor as recited in one of the preceding claims,
wherein at least one transverse flux pole (28a, 28b through 31a, 31b; 58a, 58b through 61a, 61b) is situated at an offset between two radial flux poles (15 through 18) in such a manner that a smooth variation of the armature (11) torque is achievable.

8. The reluctance motor as recited in one of the preceding claims,
wherein a first power supply system (25), in particular a first power converter, is provided for energizing the radial flux coils (21 through 24), and a second power supply system (40), in particular a second power converter, is provided for energizing the transverse flux coils (36 through 39; 66 through 69).

9. The reluctance motor as recited in claim 8,
wherein the first and second power supply systems (25, 40) are coupled together, in such a manner that the radial flux coils (21 through 24) and the transverse flux coils (36 through 39; 66 through 69) are energized in a coordinatable manner.

10. The reluctance motor as recited in claim 8 or 9,
wherein, in the event of failure of the first or second power supply system (25, 40), the other, non-failed, power supply system (40, 25) may continue to operate.

11. The reluctance motor as recited in one of claims 1 through 8,
wherein a common power supply system (51), in particular a single power converter, is provided for energizing the transverse flux coils (36 through 39; 66 through 69) and the radial flux coils (21 through 24).

12. The reluctance motor as recited in one of the preceding claims,
wherein the armature (11) is essentially made of ferrite or a sintered metal having poor electrical and good magnetic conductivity.

13. The reluctance motor as recited in one of the preceding claims,
wherein the radial flux stator (12) has an essentially annular shape.
